(19) United States
(12) Patent Application Publication
(10) Pub. No.: US 2023/0153934 A1
(43) Pub. Date: May 18, 2023

(54) SYSTEM AND METHOD FOR BULK CONSENT MANAGEMENT

(71) Applicant: CEREBRUMX LABS PRIVATE LIMITED, Haryana (IN)

(72) Inventors: Amit Gupta, Haryana (IN); Sandip Ranjhan, Delhi (IN); Sarika Gupta, Haryana (IN)

(21) Appl. No.: 17/718,286

(22) Filed: Apr. 11, 2022

(30) Foreign Application Priority Data
Nov. 17, 2021 (IN) 202111052878

(51) Int. Cl. G06Q 50/26

(52) U.S. Cl. CPC G06Q 50/265

(57) ABSTRACT

The present disclosure relates to a system (102) for managing bulk consent, the system includes a processor (202) operatively coupled to a memory, the memory storing instructions executable by the processor to receive, from a first entity (108), a bulk consent request for one or more vehicles, wherein the bulk consent request comprises a plurality of categories of automotive data, each category comprises a set of parameters associated with corresponding one or more vehicles, indicate, by the first entity (108), a set of control values associated with corresponding one or more vehicles, the set of control values control access to the set of parameters, receive, by a second entity (110), the bulk consent request from the first entity through a distributor (104) and modify the set of parameters based on the set of control values specified by the first entity in the bulk consent request.

### TECHNICAL FIELD

The present disclosure relates, in general, to consent management systems, and more specifically, relates to a system and method to collect, manage and distribute the user consent in bulk across the data chain of providers, distributors and consumers.

### BACKGROUND

Since the enforcement of data compliance laws, data privacy has been a key consideration for data collection and distribution. These compliance laws mainly focus on data ownership and need to take user consent for data collection, distribution or storage of data. Automotive data is an aggregation of data covering the following:
Vehicle profile
Vehicle health
Location
Driving patterns

Different data consumers focus on different aspects of data. For example, a fleet company shall focus on all the above aspects as they need to track the health of the vehicle, real-time location as well as driving patterns to evaluate the efficiency of their drivers. Since a fleet company may be the owner of the vehicles, they would not need to collect end-user consent to collect the vehicle-related data. In this scenario, even though a single entity can authorize the data collection and distribution, the data consumer will need to share consent for each vehicle separately. This process can be very time consuming and tedious if the data consumer does not have advanced systems to manage such transactions. Hence, an option to share the consent for all vehicles to the data provider/distributor in bulk shall be very efficient. Even for collecting and distributing user-specific data, a data consumer can collect the consent from each individual separately and then share the consent for all users in bulk with the provider/distributor.

Another aspect to be considered in consent management of the automotive data is the number of organizations involved in data collection, distribution and processing. Most of the data providers collect the data but rely on third-party data distributors to distribute the data to multiple consumers. Similarly, data consumers prefer to partner with third-party distributors, to enable data collection from a single source rather than partnering with multiple data providers/OEMs.

Typically, the data consumer such as a fleet, insurance etc., have many users enrolled in their system and may have an existing mechanism to take and maintain user consent in their systems. However, data consumers partner with vehicle manufacturers, third party vehicle data distributors to collect data related to users to make impacting business decision. For example, a fleet company may want data related to the driving pattern of their drivers, along with vehicle health data, to avoid accidents or even design driver-training programs. In compliance with data protection guidelines, these data consumers take consent from the vehicle users, data providers and distributors may take consent from vehicle users and/or data consumers. While getting user consent directly from end users is a well-established process, getting consent for multiple users via data consumer can be complex and tedious. Enabling the data distributors to give bulk consent for data collection pertaining to enrolled vehicles can simplify the process of consent across the data chain and reduce the burden on end users by giving consent only once. Hence if the consent management can be simplified on the distributor, the data consumer overheads for the consent management process can be reduced significantly.

Therefore, there is a need in the art to provide a simplified means to collect, manage and distribute the user consent in bulk across the data chain of providers, distributors and consumers

### OBJECTS OF THE PRESENT DISCLOSURE

An object of the present disclosure relates, in general, to consent management systems, and more specifically, relates to a system and method to collect, manage and distribute the user consent in bulk across the data chain of providers, distributors and consumers.

Another object of the present disclosure is to provide a system that allows a single request to contain consent details for multiple users with multiple request types.

Another object of the present disclosure is to provide a system that enables simplification of consent management process in automotive, where multiple organizations need to maintain and validate user consent, without additional burden on the users.

Another object of the present disclosure is to provide a system that is based on a standard schema and yet it gives flexibility to the sender to use their existing schema/format.

Another object of the present disclosure is to provide a system that requires only a single copy of end-user consent that can be accessed over a secure channel.

Another object of the present disclosure is to provide a system that allows the flexibility to add as many categories/parameters in the consent list without any limitation.

Another object of the present disclosure is to provide a system that can be used for sharing bulk consent between two or more partners involved in data exchange.

Another object of the present disclosure is to provide a system that submits the consent request using any mode adhering to the consent data model.

Yet another object of the present disclosure is to provide a system that provides an efficient mechanism to share bulk consent, as the user does not need to provide consent to every partner independently.

### SUMMARY

The present disclosure relates, in general, to consent management systems, and more specifically, relates to a system and method to collect, manage and distribute the user consent across the data chain of providers, distributors and consumers. The system and the method of the present disclosure enable to overcome the limitations of the prior art by sharing the consent for all vehicles to the data provider/distributor in bulk in an efficient manner.

In an aspect, the present disclosure provides a system for managing bulk consent, the system includes a processor operatively coupled to a memory, the memory storing instructions executable by the processor to receive, from a first entity, a bulk consent request for one or more vehicles, wherein the bulk consent request comprises a plurality of categories of automotive data, each category of automotive data comprises a set of parameters associated with corresponding one or more vehicles, indicate, by the first entity, a set of control values associated with corresponding one or more vehicles, the set of control values control access to the set of parameters associated with corresponding one or more vehicles, receive, by a second entity, the bulk consent request from the first entity through a distributor that interfaces with the second entity; and modify, by the second entity, the set of parameters associated with corresponding one or more vehicles based on the set of control values specified by the first entity in the bulk consent request.

According to an embodiment, the set of parameters for the plurality of categories of automotive data comprise vehicle identification number, manufacturer of the vehicle, origin of the vehicle, categories of vehicle, link, set of control values, expiry, callback and distribution.

According to an embodiment, the bulk consent request contains the set of control values for the same or different vehicles, the set of control values comprise adding consent for a new one or more vehicles, update consent for any category for an already added one or more vehicles, revoke consent for an existing one or more vehicles, remove all data related to one or more vehicles and request status of one or more vehicles.

According to an embodiment, the bulk consent request is received in the form of a consent data model to ensure compliance guidelines.

According to an embodiment, the first entity submits the bulk consent request to the distributor using any or a combination of API mode or file mode adhering to the consent data model.

According to an embodiment, the distributor, on receipt of the bulk consent request, from the first entity, configured to process, distribute and confirm that the bulk consent request is committed with the second entity.

According to an embodiment, the second entity, on receipt of the add consent request, configured to add the consent for one or more vehicles.

According to an embodiment, the second entity, on receipt of the update consent request, configured to update the existing consent for one or more vehicles.

According to an embodiment, the second entity, on receipt of the revoke consent request, configured to revoke the consent for one or more vehicles, and wherein the second entity, on receipt of the right to be forgotten (RTBF) consent request, configured to remove the consent for one or more vehicles.

In an aspect, the present disclosure provides a method for managing bulk consent using consent management system, the method includes receiving, at a processor, from a first entity, a bulk consent request for one or more vehicles, wherein the bulk consent request comprises a plurality of categories of automotive data, each category of automotive data comprises a set of parameters associated with corresponding one or more vehicles, indicating, by the first entity, a set of control values associated with corresponding one or more vehicles, the set of control values control access to the set of parameters associated with corresponding one or more vehicles, receiving, by a second entity, the bulk consent request from the first entity through a distributor that interfaces with the second entity and modifying, by the second entity, the set of parameters associated with corresponding one or more vehicles based on the set of control values specified by the first entity in the bulk consent request.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The following drawings form part of the present specification and are included to further illustrate aspects of the present disclosure. The disclosure may be better understood by reference to the drawings in combination with the detailed description of the specific embodiments presented herein.

FIG. 1A illustrates a network implementation of a consent management system, in accordance with an embodiment of the present disclosure.

FIG. 1B illustrates an exemplary representation of a system and method to collect, manage and distribute the user consent in bulk across the data chain of providers, distributors and consumers, in accordance with an embodiment of the present disclosure.

FIG. 2 illustrates exemplary functional components of the proposed system 102 in accordance with an embodiment of the present disclosure.

FIG. 3 illustrates an exemplary representation of a method for managing bulk consent, in accordance with an embodiment of the present disclosure.

FIG. 4 illustrates an exemplary computer system in which or with which embodiments of the present invention can be utilized in accordance with embodiments of the present disclosure.

### DETAILED DESCRIPTION

The following is a detailed description of embodiments of the disclosure depicted in the accompanying drawings. The embodiments are in such detail as to clearly communicate the disclosure. If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The present disclosure relates, in general, to consent management systems, and more specifically, relates to a system and method to collect, manage and distribute the user consent in bulk across the data chain of providers, distributors and consumers. In an embodiment, the system and method of the present disclosure can enable to overcome the limitations of the prior art by sharing bulk consent data between a first entity (hereinafter interchangeably referred to as a ‘data consumer’) and a second entity (hereinafter interchangeably referred to as a ‘data provider’), wherein the bulk consent can include a single request to contain consent details for multiple users with multiple request types. The term “entity” as used herein refers to a natural person, a group of natural persons, a computer system, enterprise, an organization such as a business entity, non-profit organization, or government agency, and the like. The term “enterprise” may include but is not limited to, a corporate entity, a government entity, an educational institution, an automobile entity, a medical institution, and the like. The enterprise as presented in the example can be automobile enterprises that can be large corporate automobiles. The enterprises may hold records concerning vehicles.

The bulk consent process has two endpoints a sender and a receiver. The sender has the responsibility to ensure the consent data being submitted is as per compliance rules and is responsible for the collection and maintenance of end-user consent, if deemed necessary. The receiver has the responsibility to validate the consent data, store the consent data as per compliance requirements and distribute the consent details with prior consent from the sender. The description of terms and features related to the present disclosure shall be clear from the embodiments that are illustrated and described; however, the invention is not limited to these embodiments only. Numerous modifications, changes, variations, substitutions, and equivalents of the embodiments are possible within the scope of the present disclosure. Additionally, the invention can include other embodiments that are within the scope of the claims but are not described in detail with respect to the following description.

In another embodiment, the system and method of the present disclosure can enable to overcome the limitations of the prior art by enabling a simplified consent data model/schema for bulk consent submission. The consent data model may include multiple categories of automotive data, each category of automotive data includes a set of parameters that may be entered in bulk for multiple users and submitting the set of parameters at one time. The set of control values/actions control access to the set of parameters, wherein the set of control values may include consent addition, update and revoke request from the sender and handling of these requests by the receiver.

In another embodiment, the system and method of the present disclosure can enable to overcome the limitations of the prior art by submitting the bulk consent request using any or a combination of application programming interface (API) mode or file mode adhering to the consent data model. The present disclosure can be described in enabling detail in the following examples, which may represent more than one embodiment of the present disclosure.

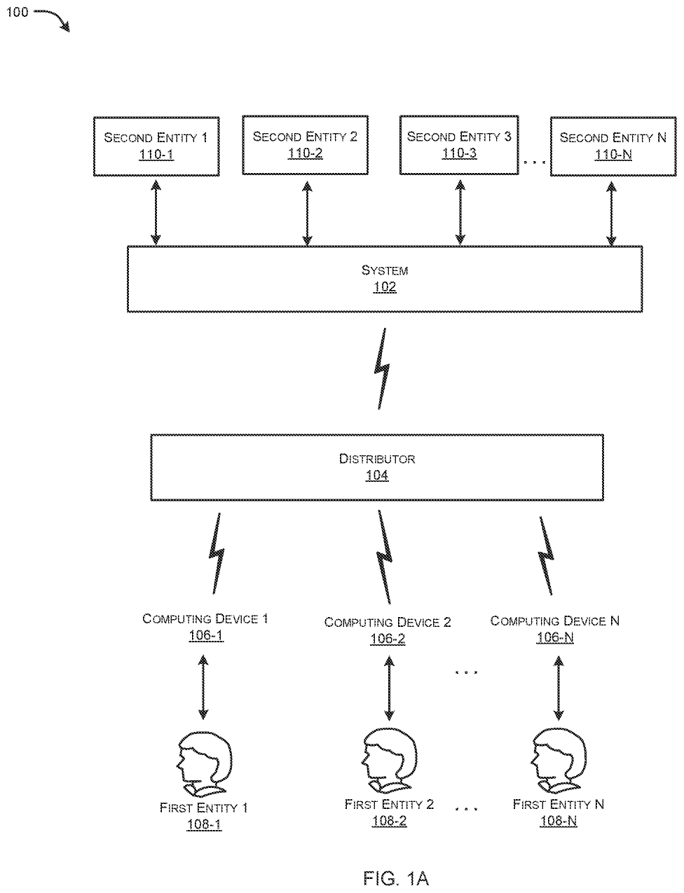

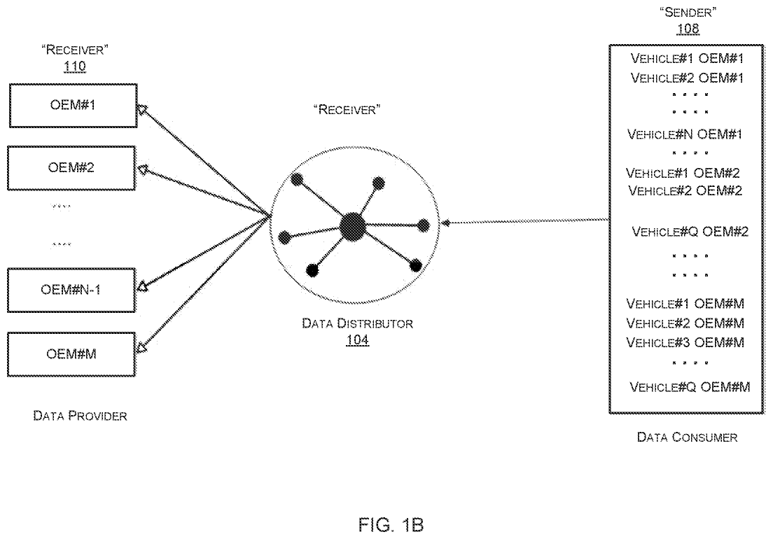

FIG. 1A illustrates a network implementation 100 of a consent management system, in accordance with an embodiment of the present disclosure.

Referring to FIG. 1A, according to a network implementation 100, a consent management system 102 (also referred to as a system 102, herein) can collect, manage and distribute the user consent in bulk across the data chain of data providers, distributors and data consumers. The system 102 can share the bulk consent request between the entities in bulk, where the entity in the system 102 may be individuals, organizations, enterprises or any other suitable parties or entities. The entity as presented in the example can be an automobile entity. As can be appreciated, the present disclosure may not be limited to this configuration but may be extended to other configurations. The system 102 may allow the entities to share data in accordance with the appropriate statutory, regulatory, ethical, and subject consent requirements.

Although the present subject matter is explained considering that the system 102 is implemented as an application on a server, it may be understood that the system 102 may also be implemented in a variety of computing systems, such as a laptop computer, a desktop computer, a notebook, a workstation, a server, a network server, a cloud-based environment and the like. It would be appreciated that the system 102 may be accessed by multiple users (also referred to as first entity) 108-1, 108-2 . . . 108-N(collectively referred to as first entities 108, and individually referred to as the first entity 108 hereinafter), through one or more computing devices 106-1, 106-2 . . . 106-N(collectively referred to as computing devices 106 and individually referred to as computing device 106, hereinafter), or set of instruction residing on the computing devices 106. The first entities 108 can be a sender (also interchangeably referred to as data consumer) that can submit bulk consent requests using API mode or file mode adhering to a standard consent data model. The sender 108 can send the data in file mode using any model as long as it has the same information as that of the consent data model. The sender 108 has the responsibility to ensure the bulk consent data/request being submitted is as per compliance rules and is responsible for the collection and maintenance of end-user consent if deemed necessary.

In an aspect, the system 102 can be operatively coupled to multiple second entities 110-1, 110-2 . . . 110-N(collectively referred to as second entities 110, and individually referred to as the second entity 110 hereinafter). The second entities 110 can be a data provider that can receive bulk consent from the sender 108 through a distributor 104. The distributor 104 (also interchangeably referred to as receiver 104, herein) is configured to support bulk consent processing, distribution and confirmation mechanism to ensure that the bulk consent submitted has been committed with all partners in the data chain. The receiver 104 processes the bulk consent request from the sender 108 and may confirm the request once it has successfully distributed the consent to relevant stakeholders (also referred to as data providers). The receiver 104 has the responsibility to validate the consent data, store the consent data as per compliance requirements and distribute the consent details with prior consent from the sender 108.

The term “entity” as used herein refers to a natural person, a group of natural persons, a computer system, electronic devices, enterprise, an organization such as a business entity, non-profit organization, or government agency, and the like. The electronic devices associated with the first entity 108 and the second entity 110 can be communicatively coupled with the system 102 through a network. Examples of the electronic devices associated with the first entity 108 and the second entity 110 may include, but are not limited to, a portable computer, a personal digital assistant, a handheld device, and the likes. In one implementation, the network can be a wireless network, a wired network or a combination thereof. The network can be implemented as one of the different types of networks, such as intranet, local area network (LAN), wide area network (WAN), the internet, and the like. Further, the network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 104 can include a variety of network devices, including routers, bridges, servers, computing devices, storage devices, and the like. In another implementation the network can be cellular network or mobile communication network based on various technologies, including but not limited to, Global System for Mobile (GSM), General Packet Radio Service (GPRS), Code Division Multiple Access (CDMA), Long Term Evolution (LTE), WiMAX, and the like.

The first entity 108 can send the data using any model as long as it has the same information as that of the consent data model.

Creating the Consent Data Model (Schema):

The consent template is designed to ensure compliance with the data protection guidelines. Below is a model for N category of data, where each category has “m” parameters (also referred to as set of parameters). The set of parameters can include vehicle identification number, manufacturer of the vehicle, origin of the vehicle, categories of vehicle, link, set of control values, expiry, callback and distribution. The set of control values can include adding consent for a new one or more vehicles, update consent for any category for an already added one or more vehicle, revoke consent for an existing one or more vehicle, remove all data related to one or more vehicles and request status of one or more vehicles. For example, the consent data model can include the following:
VIN: Vehicle Identification number for which the consent action needs to be performed
OEM: original equipment manufacturer (OEM) is manufacturer of the vehicle
Country: Country of origin of the vehicle
Category: Category for which the consent add/update is performed. Common categories for automotive data include vehicle profile, location, vehicle health, driver safety, driver behavior and any combination thereof. For each category heading, status of “Yes”/“No” specifies the consent enable/disable status
Link: Link to end user consent that must be accessible via secure channel
Action: This field specifies the requested action by the sender. It can be set to one of the following values
   ADD: To add consent for a new vehicle
   UPDATE: To update consent for any category, for an already added vehicle
   REVOKE: To revoke consent for an existing VIN
   Right To Be Forgotten (RTBF): To revoke consent and to remove all data related to VIN
   Expiry: This field must be set, when action is set to ADD or UPDATE.
   Callback: Callback function to send notifications for consent status
   Distribution: This field must be set to “Yes”, if the consent needs to be distributed to the OEM

| VIN | OEM | Country | Category#1 | Category#2 | — | Category#N | Distribution | Action | Link | Expiry | Callback |
|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

The template is designed to be flexible and can contain only the fields required for the action selected. In an embodiment, a single bulk consent request may contain multiple actions for the same or different vehicles. The list of parameters in each category, can be accessed by the sender 108.

FIG. 1B illustrates an exemplary representation of a system and method to collect, manage and distribute the user consent in bulk across the data chain of providers, distributors and consumers, in accordance with an embodiment of the present disclosure. Referring to FIG. 1B, the sender 108 using the standard consent data model can submit bulk consent request to the receiver 104 using API mode or file mode adhering to the above mentioned consent data model. The action field specifies the requested action by the sender 108. The action field can be set to one of the following values.

Add consent: The sender 108 can submit the template adding one or more VINs, for which the consent needs to be enabled, containing the following details:
a. VIN list, containing one or more VINs. For each VIN in the list the set of parameters includes:
   i. OEM and country of origin
   ii. If consent is enabled for a category of parameters, the status field should be set to “Yes”. It can be set to “No” if consent is not enabled for that category or left empty. If it is left empty, the receiver shall assume the consent to be disabled.
   iii. Action field should be set to “ADD”
   iv. Link to the user consent must be shared in adherence to compliance guidelines.
   v. Set the expiry based on the contractual obligations and end user consent expiry.
   vi. Set the callback function to get notifications, if available
   vii. Set the distribution to “Yes”/“NO” based on the need to commit the consent to OEM

Update consent: The sender 108 may need to update the consent for one or more VINs, based on the end-user consent update in their database or the sender no longer needs the data in specific category.
a. VIN List, containing one or more VINs. For each VIN in the list
   i. If consent is enabled/disabled for a category of parameters, the status field should be set to “Yes”/“No”. It can be left empty for a category. If it is left empty, the receiver shall assume the consent to disabled.
   ii. Action field should be set to “UPDATE”
   iii. Link to the updated user consent must be shared in adherence to compliance guidelines.
   iv. Set the Expiry based on the contractual obligations and end user consent expiry.
      v. Set the callback function to get notifications, if available

Revoke: The sender 108 may revoke the consent given for one or more VINs, for all categories, by specifying the
a. VIN List, containing one or more VINs. For each VIN in the list
   i. Action field set to “REVOKE”
   ii. Link to the updated user consent must be shared in adherence to compliance guidelines.
   iii. Set the callback function to get notifications, if available

Right To Be Forgotten (RTBF): The sender 108 may invoke RTBF, when the sender wants the receiver to remove all data related to one or more VINs, by specifying the
a. VIN List, containing one or more VINs. For each VIN in the list
   i. Action field set to “RTBF”
   ii. Link to the updated user consent must be shared in adherence to compliance guidelines.
   iii. Set the callback function to get notifications, if available

GETSTATUS: The sender 108 may request the consent status of one or more VINs, by specifying the
a. VIN List, containing one or more VINs. For each VIN in the list
   i. Action field set to “GET STATUS”
   ii. Set the callback function to send the status to sender

The sender 108 can send the bulk-consent request using file mode or API mode. The sender can send the data in file mode using any of the model as long as it has the information in the data model defined above.

In an embodiment, receiver 104 may support bulk consent processing, distribution and confirmation mechanism to ensure that the consent submitted has been committed with all partners in the data chain. The receiver 104 processes the bulk consent request from the sender 108 and may confirm the request once it has successfully distributed the consent to relevant stakeholders (also referred to as data provides 110, herein). For example, as depicted in FIG. 1B, the first entity 108 i.e., fleet company may give bulk consent to the distributor platform 104 that interfaces with multiple second entities 110 e.g., OEMs. The distributor must ensure, that the consent status is shared with the vehicle OEM, using the bulk consent details sent by the fleet company.

The key considerations used for processing the consent requests from the sender are as follows: The receiver 104 shall commit the consent to add request or an update request to enable the consent for a category, only when the receiver and the entities to which the consent is distributed confirm the consent addition/update. The second entity 110, on receiving the add/update consent request, configured to add/update the consent for the one or more vehicles.

The receiver 104 shall commit the consent revoke, RTBF and update request to disable the consent for a category, irrespective of the status of confirmation from other entities that may need to process the consent changes. On receiving a RTBF request, the receiver shall remove all data related to the user and shall remove the VIN record in the consent database. The second entity 110, on receiving the revoke consent request, configured to revoke the consent for one or more vehicles, and the second entity 110, on receiving the RTBF consent request, configured to remove the consent for one or more vehicles. In an exemplary embodiment, all records in the consent database shall be encrypted using AES256-CBC encryption.

In an exemplary embodiment, the database used to store the bulk consent details, where the database can be NoSQL database MongoDB. Any other NoSQL DB like DynamoDB can also be used. NoSQL DB allows the consent data to be stored as document and hence allows the flexibility to add/delete fields and categories. The set of instructions represents the consent DB collection for storing the consent details.

In addition to the consent details send by the sender 108, the receiver 104 maintains additional fields in the database record such as req_status that is the status of the consent as requested by the “sender”, con_status is the status of the consent as committed in the receiver. The default value is “0”. It is set to “1” (“Pending”), when the receiver has received the consent change for that category from the sender, but it is awaiting confirmation from the OEM on to confirm on the consent status. It is set to “2” (“Confirmed”), once the consent is committed with OEM, update_date: This field represents date and time of receiving the consent from the sender, updated_by: This field contains the name of the sender, who has submitted the consent request and consent status: This field contains the overall status of VIN consent.

The receiver 104 supports handling of file based as well as API based mode of request from the sender 108. Both modes have the same input fields. In file-based format, the sender 108 can submit bulk-consent request using their own schema. The permitted format for the file are .xlsx/xls/.csv/.xml/j son. The receiver 104 shall create a schema mapper to map the sender specific schema to a receiver recognizable schema, prior to the processing of bulk consent request from sender 108. The schema mapper is defined using add-on code to convert the schema to a standard Json schema. As an extension, schema mapper may be created using natural language processing (NLP) techniques, where the model is trained to predict and map the incoming schema details to required schema. On receiving the bulk-consent file from the sender 108, the receiver 104 converts the file format into standard schema based on Json format for API-based format, the sender 108 directly invokes the bulk consent API with parameters in j son format.

In API-based format, the sender 108 directly invokes the bulk consent API with parameters in j son format. Hence, no conversion is required. The receiver 104 processes the bulk consent request received from the sender based on the “action” specified in bulk consent request. Consent ADD: On receiving ADD request from the sender 108 to add the consent for a VIN or a group of VINs.

Consent UPDATE: On receiving a UPDATE request from the sender 108 to an existing consent for a VIN or a group of VINs.

Consent REVOKE: On receiving a REVOKE request from the sender 108 to revoke the consent for a VIN or a group of VINs.

RTBF: On receiving a RTBF request from the sender to revoke the consent for a VIN or a group of VINs.

GetStatus: On receiving a GetStatus request from the sender to get the current consent status for a VIN or a group of VINs.

The embodiments of the present disclosure described above provide several advantages. The advantages achieved by the system and method of the present disclosure can be clear from the embodiments provided herein. In an embodiment, the system 102 allows a single request to contain consent details for multiple users with multiple request types. The bulk consent request can be provided in a standard schema and yet it gives flexibility to the sender to use their existing schema/format. The system 102 requires only a single copy of end-user consent that can be accessed over a secure channel. The system 102 allows the flexibility to add as many categories/parameters in the consent list without any limitation. The system 102 can be used for sharing bulk consent between two or more than two partners involved in data exchange. The system provides an efficient mechanism to share consent, as the user does not need to provide consent to every partner independently.

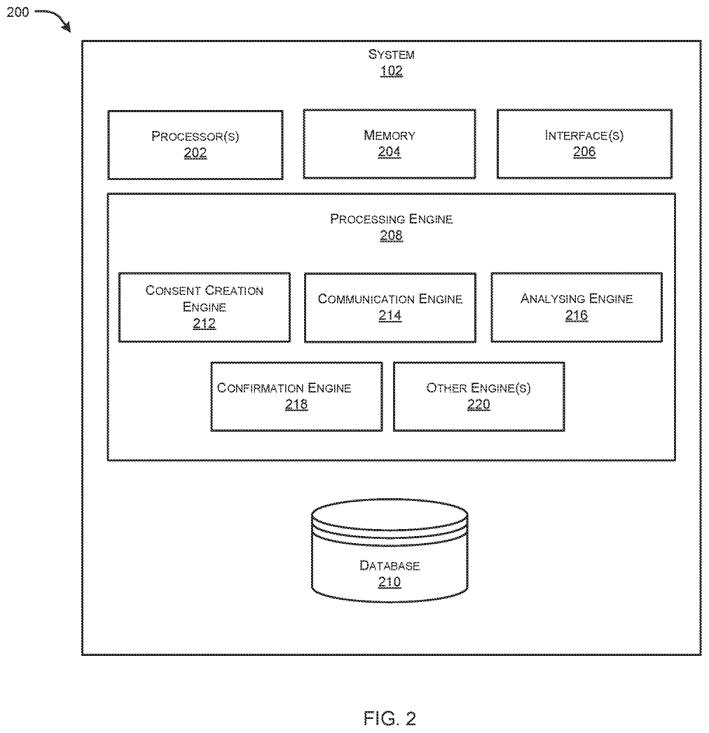

FIG. 2 illustrates exemplary functional components of the proposed system 102 in accordance with an embodiment of the present disclosure. In an aspect, the system 102 may comprise one or more processor(s) 202. In an embodiment, the processors 202 may be coupled with a memory 204 that can store instructions which when executed by the one or more processors 202 may cause the system 102 to receive, from the first entity, the bulk consent request for one or more vehicles, where the bulk consent request comprises a plurality of categories of automotive data, each category comprises a set of parameters associated with corresponding one or more vehicles. The first entity 108 indicates a set of control values associated with corresponding one or more vehicles, the set of control values control access to the set of parameters associated with corresponding one or more vehicles. The bulk consent request can be received by the second entity from the first entity through the distributor 104 that interfaces with the second entity and modify the set of parameters by the second entity based on the set of control values specified by the first entity in the consent request.

The one or more processor(s) 202 may be implemented as one or more microprocessors, microcomputers, microcontrollers, digital signal processors, central processing units, logic circuitries, and/or any devices that manipulate data based on operational instructions. Among other capabilities, the one or more processor(s) 202 are configured to fetch and execute computer-readable instructions stored in a memory 204 of the system 102. The memory 204 may store one or more computer-readable instructions or routines, which may be fetched and executed to create or share the data units over a network service. The memory 304 may comprise any non-transitory storage device including, for example, volatile memory such as RAM, or non-volatile memory such as EPROM, flash memory, and the like.

The system 102 may also comprise an interface(s) 206. The interface(s) 206 may comprise a variety of interfaces, for example, interfaces for data input and output devices, referred to as I/O devices, storage devices, and the like. The interface(s) 206 may facilitate communication of system 102. The interface(s) 206 may also provide a communication pathway for one or more components of the system 202. Examples of such components include, but are not limited to, processing engine(s) 208 and data 210.

The processing engine(s) 208 may be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor executable instructions stored on a non-transitory machine-readable storage medium and the hardware for the processing engine(s) 208 may comprise a processing resource (for example, one or more processors), to execute such instructions. In the present examples, the machine-readable storage medium may store instructions that, when executed by the processing resource, implement the processing engine(s) 208. In such examples, the system 102 may comprise the machine-readable storage medium storing the instructions and the processing resource to execute the instructions, or the machine-readable storage medium may be separate but accessible to system 102 and the processing resource. In other examples, the processing engine(s) 208 may be implemented by electronic circuitry.

The database 210 may comprise data that is either stored or generated as a result of functionalities implemented by any of the components of the processing engine(s) 208 or the system 102. In an exemplary embodiment, the processing engine(s) 208

In an exemplary embodiment, the processing engine(s) 208 may include a consent creation engine 212, a communication engine 214, analysing engine 216, confirmation engine 218 and other engine(s) 220. Other engine(s) 220 can supplement the functionalities of the processing engine 208 or the system 102.

In an embodiment, the consent creation engine 212 facilitates to create the database related to information of one or more vehicles; a communication engine facilitates the first entities to provide bulk consent request to the second entities. Analysing engine 216 analyses the information of the vehicles and add/update the consent requested by the first entity. Also, the confirmation engine 218, confirm the bulk consent request received from the first entity based on the distribution of the consent request to the second entities.

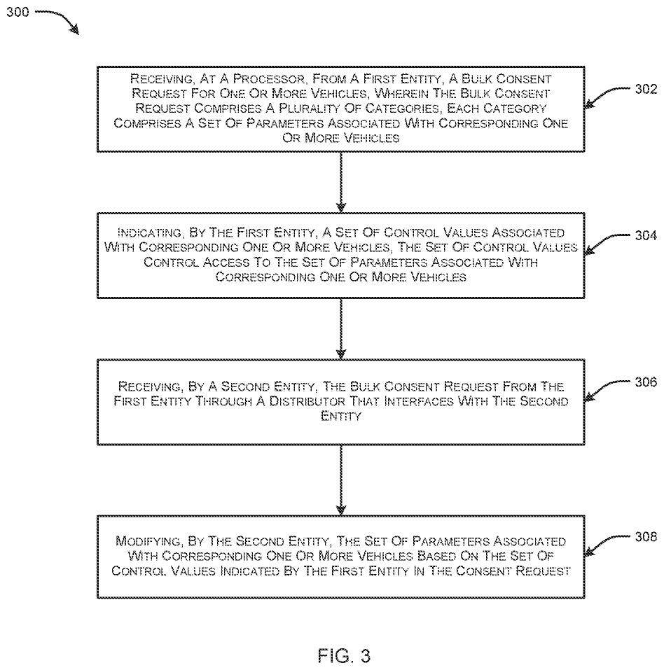

FIG. 3 illustrates an exemplary representation of a method for managing bulk consent using consent management system, in accordance with an embodiment of the present disclosure.

Referring to FIG. 3, the method 300 includes at block 302, the processor coupled to the system 102 can receive from the first entity the bulk consent request for one or more vehicles, where the bulk consent request can include a plurality of categories of automotive data, each category of automotive data comprises a set of parameters associated with corresponding one or more vehicles. At block 304, the set of control values associated with corresponding one or more vehicles is indicated by the first entity, the set of control values control access to the set of parameters associated with corresponding one or more vehicles.

At block 306, the second entity can receive the bulk consent request from the first entity through the distributor that interfaces with the second entity. At block 308, the second entity can modify the set of parameters associated with corresponding one or more vehicles based on the set of control values indicated by the first entity in the consent request.

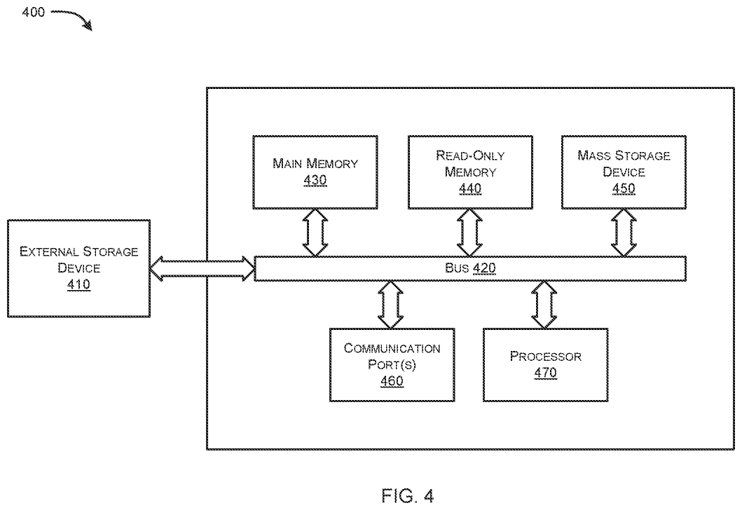

FIG. 4 illustrates an exemplary computer system in which or with which embodiments of the present invention can be utilized in accordance with embodiments of the present disclosure.

As shown in FIG. 4, computer system 400 includes an external storage device 410, a bus 420, a main memory 430, a read only memory 440, a mass storage device 450, communication port 460, and a processor 470. A person skilled in the art will appreciate that computer system may include more than one processor and communication ports. Examples of processor 470 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 470 may include various units associated with embodiments of the present invention. Communication port 460 can be any of an RS-232 port for use with a modem-based dialup connection, a 10/100 Ethernet port, a Gigabit or 10 Gigabit port using copper or fibre, a serial port, a parallel port, or other existing or future ports. Communication port 460 may be chosen depending on a network, such a Local Area Network (LAN), Wide Area Network (WAN), or any network to which computer system connects.

Memory 430 can be Random Access Memory (RAM), or any other dynamic storage device commonly known in the art. Read only memory 440 can be any static storage device(s) e.g., but not limited to, a Programmable Read Only Memory (PROM) chips for storing static information e.g., start-up or BIOS instructions for processor 470. Mass storage 450 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 420 communicatively couples processor(s) 470 with the other memory, storage, and communication blocks. Bus 420 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 470 to software system.

Optionally, operator and administrative interfaces, e.g. a display, keyboard, and a cursor control device, may also be coupled to bus 420 to support direct operator interaction with computer system. Other operator and administrative interfaces can be provided through network connections connected through communication port 460. External storage device 410 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM). Components described above are meant only to exemplify various possibilities. In no way should the aforementioned exemplary computer system limit the scope of the present disclosure.

It will be apparent to those skilled in the art that the system 102 of the disclosure may be provided using some or all of the mentioned features and components without departing from the scope of the present disclosure. While various embodiments of the present disclosure have been illustrated and described herein, it will be clear that the disclosure is not limited to these embodiments only. Numerous modifications, changes, variations, substitutions, and equivalents will be apparent to those skilled in the art, without departing from the spirit and scope of the disclosure, as described in the claims.

### Advantages of the Present Disclosure

The present disclosure provides a system that allows a single request to contain consent details for multiple users with multiple request types.

The present disclosure provides a system that enables simplification of consent management process in automotive, where multiple organizations need to maintain and validate user consent, without additional burden on the users.

The present disclosure provides a system that is based on a standard schema and yet it gives flexibility to the sender to use their existing schema/format.

The present disclosure provides a system that requires only a single copy of end-user consent that can be accessed over a secure channel.

The present disclosure provides a system that allows the flexibility to add as many categories/parameters in the consent list without any limitation.

The present disclosure provides a system that can be used for sharing bulk consent between two or more partners involved in data exchange.

The present disclosure provides a system that submits the bulk consent request using any mode adhering to the consent data model.

The present disclosure provides a system that provides an efficient mechanism to share bulk consent, as the user does not need to provide consent to every partner independently.

We claim:

1. A system (102) for managing bulk consent, said system comprising:
a processor (202) operatively coupled to a memory, the memory storing instructions executable by the processor to:
receive, from a first entity (108), a bulk consent request for one or more vehicles, wherein the bulk consent request comprises a plurality of categories of automotive data, each category of automotive data comprises a set of parameters associated with corresponding one or more vehicles;
indicate, by the first entity (108), a set of control values associated with corresponding one or more vehicles, the set of control values control access to the set of parameters associated with corresponding one or more vehicles;
receive, by a second entity (110), the bulk consent request from the first entity through a distributor (104) that interfaces with the second entity; and
modify, by the second entity, the set of parameters based on the set of control values specified by the first entity in the bulk consent request.

2. The system as claimed in claim 1, wherein the set of parameters for the plurality of categories of automotive data comprise vehicle identification number, manufacturer of the vehicle, origin of the vehicle, categories of vehicle, link, set of control values, expiry, callback and distribution.

3. The system as claimed in claim 1, wherein the bulk consent request contains the set of control values for the same or different one or more vehicles, the set of control values comprise adding consent for new one or more vehicles, update consent for any category for an existing one or more vehicles, revoke consent for the existing one or more vehicles, remove all data related to the one or more vehicles and request status of the one or more vehicles.

4. The system as claimed in claim 1, wherein said bulk consent request is received in the form of a consent data model (112) to ensure compliance guidelines.

5. The system as claimed in claim 4, wherein said first entity submits the bulk consent request to the distributor (104) using any or a combination of application programming interface (API) mode or file mode adhering to the consent data model.

6. The system as claimed in claim 1, wherein said distributor (104), on receipt of the bulk consent request, from the first entity (108), configured to process, distribute and confirm the bulk consent request is committed with the second entity (110).

7. The system as claimed in claim 1, wherein the second entity, on receipt of the add consent request, configured to add the consent for the one or more vehicles.

8. The system as claimed in claim 1, wherein the second entity, on receipt of the update consent request, configured to update the existing consent for the one or more vehicles.

9. The system as claimed in claim 1, wherein the second entity, on receipt of the revoke consent request, configured to revoke the consent for the one or more vehicles, and wherein the second entity, on receipt of right to be forgotten (RTBF) consent request, configured to remove the consent for the one or more vehicles

10. A method (300) for managing bulk consent using consent management system, said method comprising:
receiving (302), at a processor, from a first entity, a bulk consent request for one or more vehicles, wherein the bulk consent request comprises a plurality of categories of automotive data, each category of automotive data comprises a set of parameters associated with corresponding one or more vehicles;
indicating (304), by the first entity, a set of control values associated with corresponding one or more vehicles, the set of control values control access to the set of parameters associated with corresponding one or more vehicles;
receiving (306), by a second entity, the bulk consent request from the first entity through a distributor that interfaces with the second entity; and
modifying (308), by the second entity, the set of parameters associated with corresponding one or more vehicles based on the set of control values specified by the first entity in the bulk consent request.
